(19) United States
(12) Patent Application Publication
(10) Pub. No.: US 2021/0303962 A1
(43) Pub. Date: Sep. 30, 2021

(54) CHIP CARD AND METHOD FOR PRODUCING A CHIP CARD

(71) Applicant: Infineon Technologies AG, Neubiberg (DE)

(72) Inventors: Frank Pueschner, Kelheim (DE); Michael Huber, Nittendorf/Undorf (DE); Thomas Spoettl, Mintraching (DE); Peter Stampka, Burglengenfeld (DE)

(21) Appl. No.: 17/217,643

(22) Filed: Mar. 30, 2021

(30) Foreign Application Priority Data
Mar. 31, 2020 (DE) 102020108839.6

(51) Int. Cl. G06K 19/077

(52) U.S. Cl. CPC G06K 19/07747; G06K 19/07728

(57) ABSTRACT

A chip card having a chip card body with a first recess, and a chip module arranged in the recess, wherein the chip module is arranged with a distance of at most 20 μm between the chip module surface facing the bottom of the recess and the bottom of the recess, wherein the chip card body has a layer thickness from the bottom of the recess up to a surface of the chip card body facing away from the bottom of the recess of at least 200 μm.

### TECHNICAL FIELD

The disclosure relates to a chip card and a method for producing a chip card.

### SUMMARY

A chip card has a chip card body (which usually has a plastic material) and a chip card module with a chip which is embedded in the chip card body.

The chip card must be robust against mechanical loads that are usually exerted on it during the lifetime of the chip card, such as coins which press on the card in a purse in which the card is stored, and the like.

The mechanical loads are usually applied essentially perpendicular to the chip module with the chip encapsulated therein.

Within the chip module, the chip is typically connected by means of electrically conductive leads, e.g. wires. Usually, it is these connections that are damaged under excessive load and lead to the chip card becoming unusable.

In order to simulate the mechanical loads occurring in the field, a specially designed standardized test (3-wheel test) has been developed for chip cards (see CQM 2.19 and ISO 10373).

During the test, the chip card, in particular the area in which the chip module is arranged, is loaded with a dynamic mechanical force.

The test result allows conclusions to be drawn about the lifetime of the chip card when used by the user, if the usual loads such as, for example, storing coins simultaneously with the card in the purse, use of ATMs, etc. are exerted on the chip card during use.

Currently available chip cards exhibit an excessively high sensitivity to the loads applied in the test, and also to the actual loads that occur with the user, which leads to a (too) high failure rate in the field.

### SUMMARY

In various exemplary aspects, a chip card with an increased robustness to mechanical loads is provided. This can reduce a failure rate in the field.

### BRIEF DESCRIPTION OF THE DRAWINGS

Exemplary aspects of the disclosure are illustrated in the figures and will be explained in more detail below. In the figures

FIG. 1 shows a schematic cross-sectional view of an area of a chip card according to the known art;

FIG. 2 shows a schematic cross-sectional view of an area of a chip card according to various exemplary aspects; and

FIG. 3 shows a flowchart of a method for producing a chip card according to various exemplary aspects.

### DETAILED DESCRIPTION

In the following detailed description, reference is made to the attached drawings, which form part thereof and in which specific aspects in which the disclosure can be carried out are shown for illustrative purposes. In this respect, directional terminology such as “top”, “bottom”, “front”, “back”, “front”, “rear”, etc. is used with reference to the orientation of the described figure(s). Since components of aspects can be positioned in a number of different orientations, the directional terminology is used for illustrative purposes and is in no way restrictive. It is understood that other aspects can be used and structural or logical changes can be made without deviating from the protective scope of the present disclosure. It is understood that the characteristics of the various exemplary aspects described herein can be combined with each other, unless specifically otherwise indicated. The following detailed description is therefore not to be interpreted in a restrictive sense, and the protective scope of the present disclosure is defined by the appended claims.

Within the context of this description, the terms “connected” and “coupled” are used to describe both a direct and an indirect connection and a direct or indirect coupling. In the figures identical or similar elements are provided with identical designations, as far as this is appropriate.

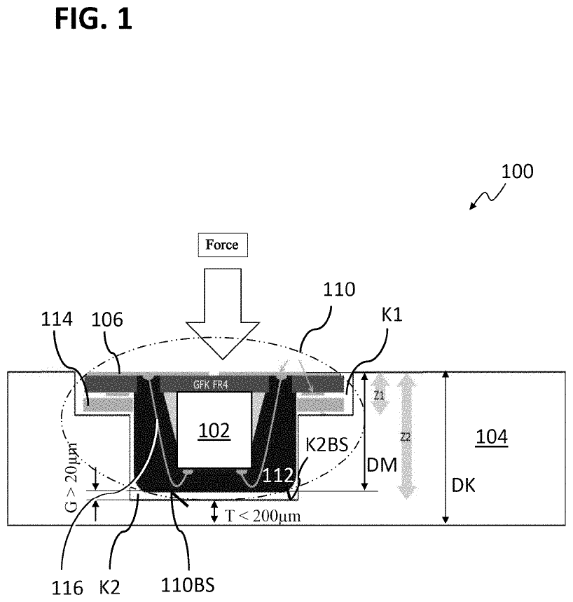

FIG. 1 shows a schematic cross-sectional view of an area of a chip card 100 according to the known art.

The chip card 100 has a card body 104 and a chip module 110 embedded therein, which contains a chip 102.

Nowadays, a specification for a thickness DM of the chip module 110 (also referred to as the chip card module) is 580 μm. Accordingly, a recess is formed in which the chip module 110 is to be arranged, with a depth of at least 580 μm plus a tolerance of about 20 μm, which would lead to a depth Z2 of the recess K2 (also referred to as a cavity) of about 600 μm to 620 μm.

A specification for a card thickness DK is specified in the ISO 7810 standard at 760 μm±80 μm.

In reality, however, the module thickness DM is on average only 540 μm, and the card thickness DK is on average about 800 μm.

These actually implemented dimensions lead to a distance G of at least about 40 μm being formed between a bottom surface K2BS of the recess K2 and an opposite lower surface 110BS of the chip module 110 (which may be formed, for example, by encapsulation material 112).

In addition, a layer thickness T of the card body 104 in the area of the chip module 110, or in the area of the recess K2 in which the chip module is arranged is then at most only about 180 μm.

This means that the force exerted on the module (see arrow) will press the module 110 in the direction of the card bottom below the recess, which will lead to an enormous bending amplitude of more than 40 μm because of the distance G, which is at least 40 μm, and because of the low layer thickness T of the card body 104 in the area of the recess K2, which results in the card body 104 not being stable enough to counteract excessively severe bending.

With the dimensions described, bending may result in damage to the encapsulation 104 and/or breaking/tearing of wires or leads 116.

In various exemplary aspects, a chip card is provided in which it is ensured that both a distance between the lower surface of the chip module and a bottom of a recess in which the chip module is arranged is less than 20 μm, and a layer thickness of the card body in the area of the recess is more than 200 μm.

This can achieve the effect that possible bending of the chip card is so limited that there is no mechanical damage, or that the probability of damage is at least reduced.

Failures in the field can therefore be prevented.

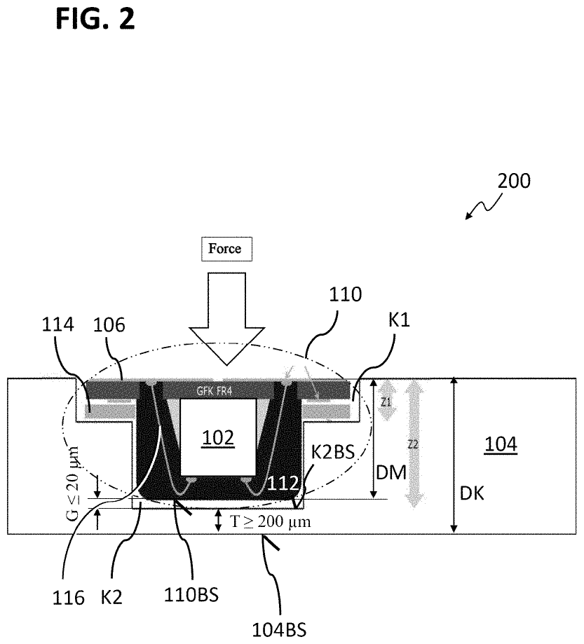

FIG. 2 shows a schematic cross-sectional view of an area of a chip card 200 according to various exemplary aspects.

The chip card 200 has a chip card body 104 with a recess K1+K2, and a chip module 110, which has a chip 102 and is arranged in the recess K1+K2. The chip module can be fastened in the recess K1+K2, for example, by means of an adhesive 114, e.g. by means of a hot melt. The chip card 200 can have a thickness of at most 840 μm.

The chip card body 104 with the recess K1+K2 can be formed substantially by means of known methods and materials. For example, the chip card body 104 may have plastic or consist of it, for example, a laminate made of a plurality of layers of different plastic materials and coatings.

The recess K1+K2 can be formed, for example, by milling. The recess K1+K2 can have a first recess K1, in which a part of the chip module 110 is arranged, and a second recess K2, which extends from the first recess K1 deeper into the chip card body 104, and in which that area of the chip module 110 in which a chip 102 is located is arranged.

The chip module 110 can have a thickness DM of at most 600 μm, e.g. at most 580 μm, e.g. at most 560 μm, e.g. at most 550 μm, e.g. at most 540 μm.

The chip module 110 can be arranged with a distance of at most 20 μm, e.g. at most 18 μm, e.g. at most 16 μm, e.g. at most 14 μm, e.g. at most 12 μm, e.g. at most 10 μm between the chip module surface 110BS which faces the bottom K2BS of the recess K2, and the bottom K2BS of the recess K2.

In this case, the chip card body 104 can have a layer thickness T from the bottom K2BS of the recess K2 up to a surface of the chip card body facing away from the bottom K2BS of the recess K2 of at least 200 μm, e.g. at least 210 μm, e.g. at least 220 μm, e.g. at least 230 μm, e.g. at least 240 μm, e.g. at least 250 μm.

Dimensions and distances of the chip card 200 are thus chosen in such a way that it is ensured that both the distance G between the lower surface of the chip module 110 and the bottom K2BS of the recess K2 is less than 20 μm, and the layer thickness T of the card body 104 in the area of the recess K2 is more than 200 μm.

It can thus be ensured that the bending of the chip card 200 is so low in both the test and in the field that no damage to the chip module 110 and its interconnecting leads 116 is to be expected.

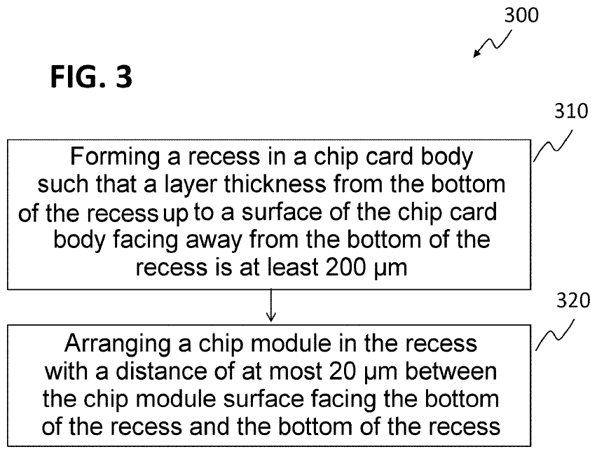

FIG. 3 shows a flowchart of a method for producing a chip card according to various exemplary aspects.

The method has a formation of a recess in a chip card body such that a layer thickness from the bottom of the recess up to a surface of the chip card body facing away from the bottom of the recess is at least 200 μm (at 310), and an arrangement of a chip module in the recess with a distance of at most 20 μm between the chip module surface facing the bottom of the recess and the bottom of the recess (at 320).

In various exemplary aspects, before forming the recess, a determination of a mean thickness for a plurality of the chip modules can be made.

Then, the recess can be formed with a depth corresponding to a sum of the mean thickness and a predetermined value for the distance (of at most 20 μm) between the chip module surface facing the bottom of the recess and the bottom of the recess.

Some exemplary aspects are summarized below.

Exemplary aspect 1 is a chip card. The chip card has a chip card body with a recess, and a chip module arranged in the recess, wherein the chip module is arranged with a distance of at most 20 μm between the chip module surface facing the bottom of the recess and the bottom of the recess, wherein the chip card body has a layer thickness from the bottom of the recess up to a surface of the chip card body facing away from the bottom of the recess of at least 200 μm.

Exemplary aspect 2 is a chip card according to exemplary aspect 1, wherein the layer thickness from the bottom of the recess up to a surface of the chip card body facing away from the bottom of the recess is at least 210 μm, optionally at least 220 μm, optionally at least 230 μm, optionally at least 240 μm, optionally at least 250 μm.

Exemplary aspect 3 is a chip card according to exemplary aspect 1 or 2, wherein the chip module is arranged with a distance of at most 18 μm, optionally at most 16 μm, optionally at most 14 μm, optionally at most 12 μm, optionally at most 10 μm between the chip module surface facing the bottom of the recess and the bottom of the recess.

Exemplary aspect 4 is a chip card according to one of the exemplary aspects 1 to 3, wherein the chip module has a thickness of at most 600 μm, optionally at most 580 μm, optionally at most 560 μm, optionally at most 550 μm, optionally at most 540 μm.

Exemplary aspect 5 is a chip card according to one of the exemplary aspects 1 to 4, wherein the chip card has a thickness of at most 840 μm.

Exemplary aspect 6 is a method for producing a chip card. The method comprises forming a recess in a chip card body such that a layer thickness from the bottom of the recess up to a surface of the chip card body facing away from the bottom of the recess is at least 200 μm, and arranging a chip module in the recess with a distance of at most 20 μm between the chip module surface facing the bottom of the recess and the bottom of the recess.

Exemplary aspect 7 is a method according to exemplary aspect 6, wherein the layer thickness from the bottom of the recess up to a surface of the chip card body facing away from the bottom of the recess is at least 210 μm, optionally at least 220 μm, optionally at least 230 μm, optionally at least 240 μm, optionally at least 250 μm.

Exemplary aspect 8 is a method according to exemplary aspect 6 or 7, wherein the chip module is arranged with a distance of at most 18 μm, optionally at most 16 μm, optionally at most 14 μm, optionally at most 12 μm, optionally at most 10 μm between the chip module surface facing the bottom of the recess and the bottom of the recess.

Exemplary aspect 9 is a method according to one of the exemplary aspects 6 to 8, wherein the chip module has a thickness of at most 600 μm, optionally at most 580 μm, optionally at most 560 μm, optionally at most 550 μm, optionally at most 540 μm.

Exemplary aspect 10 is a method according to one of the exemplary aspects 6 to 9, wherein the chip card has a thickness of at most 840 μm.

Exemplary aspect 11 is a method according to one of the exemplary aspects 6 to 9 which further, before the formation of the recess, comprises a determination of a mean thickness for a plurality of chip modules, wherein the recess is formed with a depth corresponding to a sum of the mean thickness and a predetermined value for the distance between the chip module surface facing the bottom of the recess and the bottom of the recess.

Further advantageous refinements of the device can be gathered from the description of the method and vice versa.

What is claimed is:

1. A chip card, comprising:
a chip card body having a recess; and
a chip module arranged in the recess, wherein the chip module is arranged with a distance of at most 20 μm between the chip module surface facing the bottom of the recess and the bottom of the recess;
wherein the chip card body has a layer thickness from the bottom of the recess up to a surface of the chip card body facing away from the bottom of the recess of at least 200 μm.

2. The chip card as claimed in claim 1,
wherein the layer thickness from the bottom of the recess up to a surface of the chip card body facing away from the bottom of the recess is at least 210 μm.

3. The chip card as claimed in claim 1,
wherein the layer thickness from the bottom of the recess up to a surface of the chip card body facing away from the bottom of the recess is at least 240 μm.

4. The chip card as claimed in claim 1,
wherein the layer thickness from the bottom of the recess up to a surface of the chip card body facing away from the bottom of the recess is at least 250 μm.

5. The chip card as claimed in claim 1,
wherein the chip module is arranged with a distance of at most 18 μm between the chip module surface which faces the bottom of the recess and the bottom of the recess.

6. The chip card as claimed in claim 1,
wherein the chip module is arranged with a distance of at most 12 μm between the chip module surface which faces the bottom of the recess and the bottom of the recess.

7. The chip card as claimed in claim 1,
wherein the chip module is arranged with a distance of at most 10 μm between the chip module surface which faces the bottom of the recess and the bottom of the recess.

8. The chip card as claimed in claim 1,
wherein the chip module has a thickness of at most 600 μm.

9. The chip card as claimed in claim 1,
wherein the chip module has a thickness of at most 550 μm.

10. The chip card as claimed in claim 1,
wherein the chip module has a thickness of at most 540 μm.

11. The chip card as claimed in claim 1,
wherein the chip card has a thickness of at most 840 μm.

12. A method for producing a chip card, comprising:
forming a recess in a chip card body such that a layer thickness from the bottom of the recess up to a surface of the chip card body facing away from the bottom of the recess is at least 200 μm; and
arranging a chip module in the recess with a distance of at most 20 μm between the chip module surface facing the bottom of the recess and the bottom of the recess.

13. The method as claimed in claim 12,
wherein the layer thickness from the bottom of the recess up to a surface of the chip card body facing away from the bottom of the recess is at least 210 μm.

14. The method as claimed in claim 12,
wherein the layer thickness from the bottom of the recess up to a surface of the chip card body facing away from the bottom of the recess is at least 250 μm.

15. The method as claimed in claim 12,
wherein the chip module is arranged with a distance of at most 18 μm between the chip module surface facing the bottom of the recess and the bottom of the recess.

16. The method as claimed in claim 6,
wherein the chip module is arranged with a distance of at most 10 μm between the chip module surface facing the bottom of the recess and the bottom of the recess.

17. The method as claimed in claim 12,
wherein the chip module has a thickness of at most 600 μm.

18. The method as claimed in claim 12,
wherein the chip module has a thickness of at most 540 μm.

19. The method as claimed in claim 12,
wherein the chip card has a thickness of at most 840 μm.

20. The method as claimed in claim 12, further comprising:
before the formation of the recess, a determination of a mean thickness for a plurality of chip modules;
wherein the recess is formed with a depth corresponding to a sum of the mean thickness and a predetermined value for the distance between the chip module surface facing the bottom of the recess and the bottom of the recess.
